(19) United States
(12) Patent Application Publication
(10) Pub. No.: US 2019/0028541 A1
(43) Pub. Date: Jan. 24, 2019

(54) INTEGRATED CONVERGED STORAGE ARRAY

(71) Applicant: Hewlett Packard Enterprise Development LP, Houston, TX (US)

(72) Inventor: Siamack Ayandeh, Andover, MA (US)

(21) Appl. No.: 16/070,914

(22) PCT Filed: Jan. 29, 2016
(86) PCT No.: PCT/US2016/015821

§ 371 Date: Jul. 18, 2018

(51) Int. Cl. H04L 29/08; H04L 12/931; H04L 12/947; H04L 12/721; H04L 12/715; H04L 29/06

(52) U.S. Cl. CPC H04L 67/1097; H04L 49/357; H04L 69/18; H04L 45/66; H04L 45/64; H04L 49/25

(57) ABSTRACT

Example implementations relate to storage arrays accessible via a network. For example, an integrated storage array interface may include: a processor; a converged physical layer (PHY) device coupled to the processor, and coupled to a storage area network (SAN) via a plurality of converged ports which are operable according to a plurality of protocols; and a layer 2 switch coupled to the processor, the converged PHY device, and coupled to a backend storage resource via a storage controller. The converged ports are configurable to operate according to each of the plurality of protocols.

### BACKGROUND

Datacenters and cloud storage arrays are often accessible via a variety of input/output (I/O) protocols, such as Fibre Channel, Fibre Channel over Ethernet (FCoE), internet Small Computer System Interface (iSCSI), Internet Protocol (IP), and so on. These I/O protocols allow for such storage arrays to be accessed over a networking fabric. Generally, these I/O protocols are supported using several network interface adapters.

### BRIEF DESCRIPTION OF THE DRAWINGS

FIG. 1 is a block diagram illustrating an example storage array, according to the present examples.

FIG. 2 is a block diagram illustrating another example storage array, according to the present examples.

FIG. 3 is a block diagram illustrating an example storage array interface, according to the present examples.

### DETAILED DESCRIPTION

Examples such as described provide for integrated storage array interfaces. According to an example, an integrated storage array interface may include a processor, a converged physical layer (PHY) device coupled to the processor, and coupled to a storage area network (SAN) via a plurality of converged ports which are configurable to operate according to each of a plurality of protocols, and a layer 2 switch coupled to the processor, the converged PHY device, and coupled to a backend storage resource via a storage controller.

In another example, an integrated storage array may include a storage array controller, a switching resource coupled between a SAN and the storage array controller, and a storage resource coupled to the storage array controller. The switching resource is coupled to the storage array controller via a backplane PHY, and coupled to the SAN via a plurality of converged ports which are configurable to operate according to each of a plurality of protocols.

In another example, an integrated storage array interface may provide access to a storage resource and include a converged PHY coupled to a SAN and capable of communicating with the SAN via a plurality of protocols, a switching resource coupled to the configurable PHY and coupled to the storage resource via a storage array controller, and a processing resource coupled to the converged PHY and to the switching resource. The converged PHY is coupled to the SAN via a plurality of converged ports, which are configurable to operate according to each of the plurality of protocols.

Aspects described herein provide that methods, techniques and actions performed by a computing device are performed programmatically, or as a computer-implemented method. Programmatically means through the use of code, or computer-executable instructions. A programmatically performed step may or may not be automatic.

Examples described herein can be implemented using engines, which may be any combination of hardware and programming to implement the functionalities of the engines. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In such examples, the at least one machine-readable storage medium may store instructions that, when executed by the at least one processing resource, implement the engines. In examples, a system may include the machine-readable storage medium storing the instructions and the processing resource to execute the instructions, or the machine-readable storage medium may be separate but accessible to the system and the processing resource.

Furthermore, aspects described herein may be implemented through the use of instructions that are executable by a processor or combination of processors. These instructions may be carried on a non-transitory computer-readable medium. Computer systems shown or described with figures below provide examples of processing resources and computer-readable mediums on which instructions for implementing some aspects can be carried and/or executed. In particular, the numerous machines shown in some examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, aspects may be implemented in the form of computer programs.

As discussed above, storage arrays may support a number of I/O protocols, such as Fibre Channel, FCoE, iSCSI, IP, and so on. Generally, these protocols are supported by a number of network interface cards. For example, one network interface card may support Fibre Channel, while another may support FCoE, another iSCSI, another IP, and so on. The network interface cards may include one or more application-specific integrated circuits (ASICs) which may require custom software, and design to support a given I/O protocol. Each network interface card may interface with a storage array controller using a protocol such as PCI Express (PCI-e) in order to access the storage media. Sufficient numbers of each type of network interface card must then be provided for I/O to a SAN. Because a large number of users, or hosts, may use a storage array, providing sufficient numbers of each type of network interface card may result in storage arrays having a large physical dimension, requiring a large number of PCI-e slots, having an unacceptably large power consumption, and a high cost.

Examples as described recognize the shortcomings of conventional approaches with respect to network interface cards in storage arrays. Examples as described may provide lower cost, flexible, and configurable storage array interfaces using converged ports which may be configurable to support multiple I/O protocols.

Examples as described provide for integrated storage array interfaces which may include a switch, such as a layer 2 Ethernet switch, coupled to a converged physical layer (PHY) device having a number of converged ports. These converged ports may be configurable to support operation according to a number of I/O protocols, such as Fibre Channel, FCoE, iSCSI, IP, and so on. The switch may be coupled to a storage array controller via Ethernet, such as a number of 10G Ethernet ports. The storage array controller may provide access to storage media using a suitable storage access technology such as Fibre Channel Loop (FC Loop), Shared Serial-Attached SCSI (SAS), and so on. Such integrated storage array interfaces may allow efficient, low-cost, and low-power operations, as the expense and complexity of providing separate network interface cards for each I/O protocol may be removed. For example, supporting multiple I/O protocols using converged ports may reduce the number of ASICs required for a given storage array, which may allow for reduced cost, power consumption, and a smaller physical dimension. Additionally, providing support for such converged storage array interfaces may provide flexibility for changing storage array access conditions (e.g., as a proportion of accesses via the supported I/O protocols changes, the converged ports may be configured to support the changing conditions) Additionally, future I/O protocols may be supported without requiring a separate network interface card. For example, Remote DMA (RDMA) may be supported in software, as it simply requires a lossless Ethernet fabric and suitable software drivers. Other I/O protocols supporting Ethernet encapsulation may similarly be supported using appropriate software.

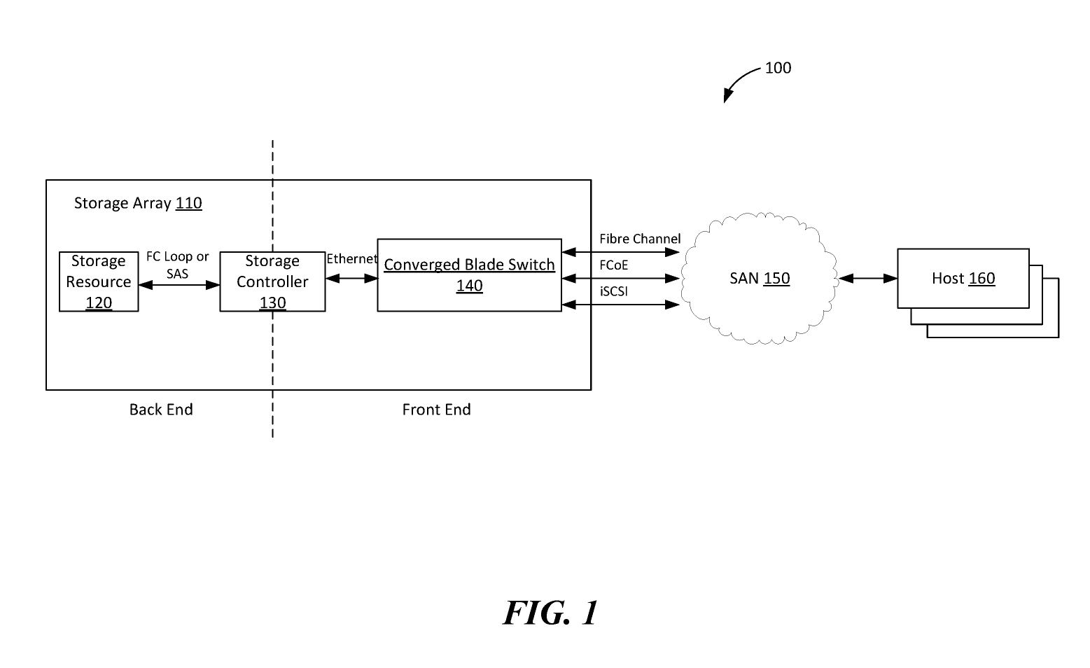

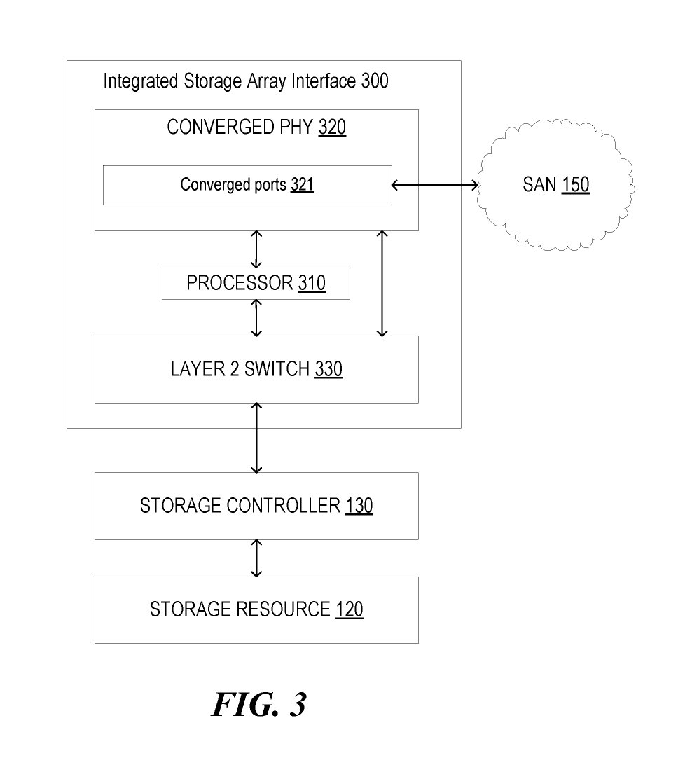

FIG. 1 shows an example storage array architecture 100, in accordance with the present examples. With respect to FIG. 1, a storage array 110 may be accessible to hosts 160, via a storage access network (SAN) 150. The storage array 110 may be accessible via a plurality of I/O protocols, such as Fibre Channel, FCoE, iSCSI, IP and so on. Additionally, a storage controller 130 may be coupled to storage resource 120 via a back end protocol such as FC Loop, SAS, or another suitable protocol. However, rather than including a plurality of network interface cards, storage array 110 may include a converged blade switch 140, which may support operations according to the plurality of I/O protocols. For example, converged blade switch 140 may support operations according to Fibre Channel, FCoE, iSCSI, and other suitable protocols, via a plurality of converged ports (described in more detail below with respect to FIG. 3). In addition, converged blade switch 140 may be coupled to storage controller 130 via a lossless Ethernet connection, rather than PCI-e. For a number of I/O protocols, this may provide a common end-to-end transport protocol for storage traffic, and thus avoid the need for multiple fabrics to be provided, each using a different technology. For some examples, this lossless Ethernet connection to storage controller 130 may be a 10G, 25G, 40G, 50G, or 100G Ethernet port. In some other examples the Ethernet connection may include multiple such ports. Storage controller 130 may include multiple controller nodes, each coupled to converged blade switch 140 and to storage media 120. For some examples, the converged ports of converged blade switch 140 may be allocated among the storage controller nodes according to an expected distribution of storage array network traffic. As shown in FIG. 1, storage controller 130 may bridge the “back end” and the “front end” of the storage array 110.

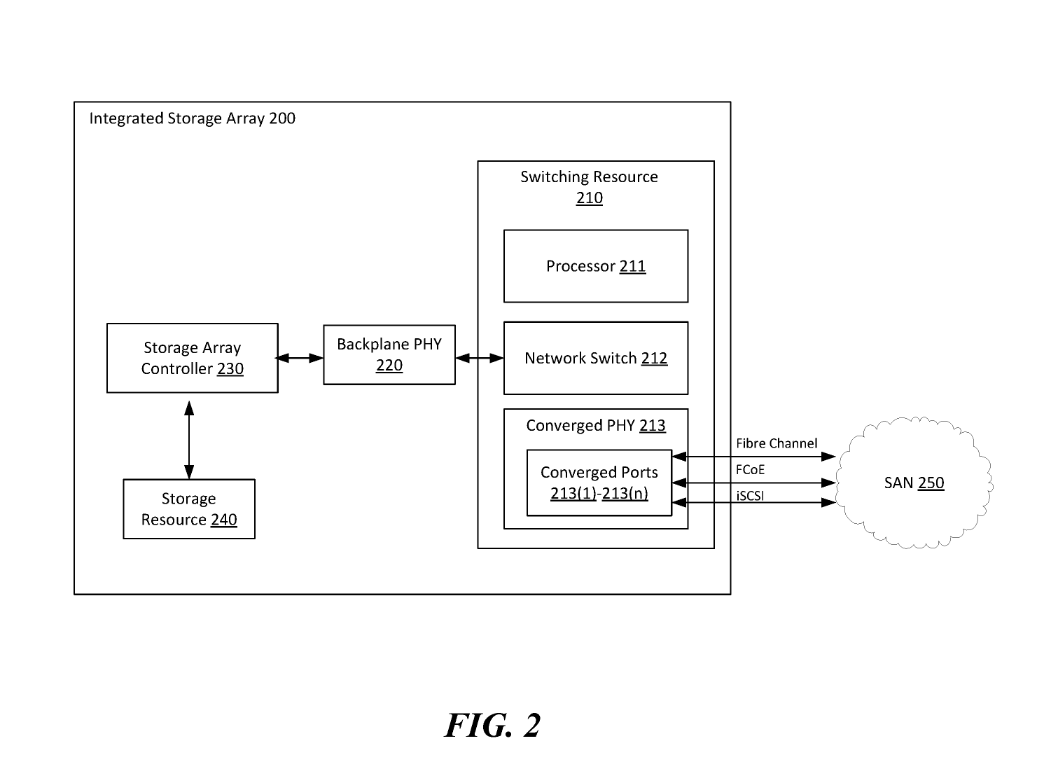

FIG. 2 shows an example integrated storage array 200, according to the present examples. Integrated storage array 200 may be one example of storage array 110 of FIG. 1. In particular, storage resource 240 may be one example of storage media 120, storage array controller 230 may be one example of storage controller 130, and switching resource 210 may be one example of converged blade switch 140. With respect to FIG. 2, integrated storage array 200 may include a switching resource 210, coupled between a backplane PHY 220 and a SAN 250. More particularly, switching resource 210 may include a processor 211, a network switch 212, and a converged PHY 213. Network switch 212 may couple switching resource 210 to a backplane PHY 220 via a suitable protocol, such as via a lossless Ethernet connection. In some examples, network switch 212 may be a layer 2 switch. In some examples, processor 211 may be configured to determine a processing capability of storage array controller 230, and cause network switch 212 to match the determined processing capability. For example, a processing capability may include an I/O operations per second (IOPS) associated with storage array controller 230. Switching resource 210 may also include a converged PHY 213, including a number of converged ports 213(1)-213(n). The converged ports 213 may be configured to operate according to each a plurality of I/O protocols to couple switching resource 210 to SAN 250. For example, each of the converged ports 213 may be operable according to Fibre Channel, FCoE, iSCSI, IP, or other suitable protocols.

When configured to operate according to a Fibre Channel or an FCoE protocol, switching resource 210 may be configured to present a virtual fabric port (VF Port), a virtual extender port (VE port) or another suitable port type to SAN 250 or to hosts (if connected directly to a host). Alternatively, for FCoE fabrics, switching resource 210 may be configured to operate as a layer 2 Ethernet switch, an N port virtualization (NPV) device, or a Fibre Channel Forwarded (FCF) device. When interfacing via iSCSI or IP, switching resource 210 may operate as a lossless layer 2 Ethernet switch. In some other examples, other protocols supporting Ethernet encapsulation, such as RDMA, may be supported by providing appropriate software drivers.

As discussed above, switching resource 210 may be coupled to storage array controller via a backplane PHY 220. Storage array controller 230 may then be coupled to a storage resource 240 using a back end protocol such as FC Loop, SAS, or another suitable protocol. For some examples, storage array controller 230 may include a plurality of storage array controller nodes, each of which is connected to switching resource 210 via backplane 220. For some examples, the converged ports 213 of switching resource 210 may be allocated among the plurality of storage array controller nodes according to an expected distribution of storage array network traffic.

While storage array controller 230 and switching resource 210 are depicted in FIG. 2 as separate modules, in some examples, a network processor unit (NPU) having a plurality of cores, or another suitable multiprocessor system may perform the functions of the storage array controller and/or the switching resource. For example, while a storage array controller may include a LAN on Motherboard (LoM), which may connect the controller to the switching resource (e.g., via an Ethernet connection), when the switching resource is implemented as an NPU, the LoM function may be performed by the NPU rather than by a separate controller. Similarly, other functions of the controller may be incorporated into such an NPU.

FIG. 3 is a block diagram that illustrates an example integrated storage array interface 300, according to the present embodiments. For example, in the context of FIGS. 1-2, integrated storage array interface 300 may be one example implementation of converged blade switch 140 or switching resource 210. In an embodiment, integrated storage array interface 300 may include a processor 310, a converged PHY device 320, and a layer 2 switch 330. With respect to FIG. 3, converged PHY 320 may be coupled to processor 310 and to a storage area network 150 via a plurality of converged ports 321. As described above, each of the converged ports 321 may be configurable to operate according to each of a plurality of protocols. In some examples, the converged ports are configurable to operate as Fibre Channel ports, FCoE ports, or as lossless Ethernet ports for iSCSI and IP protocols. In some other examples, other protocols which support Ethernet encapsulation may be supported by the converged ports, such as RDMA. The integrated storage array interface 300 also includes a layer 2 switch 330 coupled to the processor, the converged PHY device 320, and coupled to a storage resource 120 via a storage controller 130. In some examples, the layer 2 switch is coupled to the storage resource via a lossless Ethernet connection. As described above, in some examples, the layer 2 switch 330 may be a network processor. For some implementations, processor 310 may be configured to determine a processing capability of storage controller 130, and cause layer 2 switch 330 to match the determined processing capability. For example, a processing capability may include an I/O operations per second (IOPS) associated with storage controller 130. For some other embodiments, storage controller 130 may include a plurality of storage controller nodes, and the converged ports 321 may be allocated among the storage controller nodes according to an expected distribution of storage array network traffic.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an embodiment, can be combined with other individually described features, or parts of other aspects. Thus, absence of describing combinations should not preclude the inventor(s) from claiming rights to such combinations.

What is claimed is:

1. An integrated storage array interface comprising:
a processor;
a converged physical layer (PHY) device coupled to the processor and coupled to a storage area network (SAN) via a plurality of converged ports which are configurable to operate according to a plurality of protocols; and
a layer 2 switch coupled to the processor, the converged PHY device, and coupled to a backend storage resource via a storage controller.

2. The integrated storage array interface of claim 1, wherein the layer 2 switch is coupled to the storage controller via a lossless Ethernet connection.

3. The integrated storage array interface of claim 1, wherein the converged ports are configurable to operate as a Fibre Channel port, as a Fibre Channel over Ethernet (FCoE) port, or as a lossless Ethernet port, and the plurality of protocols include a Fibre Channel protocol, an FCoE protocol, an internet Small Computer System Interface (iSCSI) protocol, and an IP protocol.

4. The integrated storage array interface of claim 1, wherein the processor causes the layer 2 switch to match a processing capability of the storage controller.

5. The integrated storage array interface of claim 1, wherein the layer 2 switch is a network processor.

6. The integrated storage array interface of claim 1, wherein:
the storage controller includes a plurality of storage controller nodes; and
the plurality of converged ports is allocated among the storage controller nodes according to an expected distribution of storage array network traffic.

7. An integrated storage array, comprising:
a storage array controller;
a switching resource coupled between a storage area network (SAN) and the storage array controller; and
a storage resource coupled to the storage array controller;
wherein the switching resource includes a network switch coupled to the storage array controller via a backplane PHY; and
wherein the switching resource is coupled to the SAN via a plurality of converged ports, the converged ports configurable to operate according to each of a plurality of protocols.

8. The integrated storage array of claim 7, wherein the network switch is a layer 2 switch coupled to the storage array controller via a lossless Ethernet connection.

9. The integrated storage array of claim 8, wherein the switching resource causes the layer 2 switch to match a processing capability of the storage array controller.

10. The integrated storage array of claim 8, wherein the layer 2 switch is a network processor.

11. The integrated storage array of claim 8, wherein:
the storage array controller includes a plurality of storage controller nodes;
the layer 2 switch is coupled to the plurality of storage controller nodes via a plurality of ports; and
the plurality of ports is allocated among the storage controller nodes according to an expected distribution of storage array network traffic.

12. The integrated storage array of claim 7, wherein the converged ports are configurable to operate as a Fibre Channel port, as a Fibre Channel over Ethernet (FCoE) port, or as a lossless Ethernet port, and the plurality of protocols include a Fibre Channel protocol, an FCoE protocol, an internet Small Computer System Interface (iSCSI) protocol, and an IP protocol.

13. An integrated storage array interface providing access to a storage resource and comprising:
a converged physical layer (PHY) device coupled to a storage area network (SAN) and capable of communicating with the SAN via a plurality of protocols;
a switching resource coupled to the converged PHY device and coupled to the storage resource via a storage array controller; and
a processing resource coupled to the converged PHY device and to the switching resource;
wherein the converged PHY device is coupled to the SAN via a plurality of converged ports, each of the plurality of converged ports configurable to operate according to each of the plurality of protocols.

14. The integrated storage array interface of claim 13, wherein the switching resource includes a layer 2 switch coupled to the storage array controller via a lossless Ethernet connection; and
wherein the switching resource causes the layer 2 switch to match a processing capability of the storage array controller.

15. The integrated storage array interface of claim 14, wherein:
the storage array controller includes a plurality of storage controller nodes;
the layer 2 switch is coupled to the plurality of storage controller nodes via a plurality of ports; and
the plurality of ports is allocated among the storage controller nodes according to an expected distribution of storage array network traffic.
